(19) United States
(12) Patent Application Publication
(10) Pub. No.: US 2023/0312971 A1
(43) Pub. Date: Oct. 5, 2023

(54) FADE RESISTANT EXTERIOR PAINT FORMULATION

(71) Applicant: BEHR PROCESS CORPORATION, Santa Ana, CA (US)

(72) Inventors: Yunfei JIANG, Irvine, CA (US); Tom HOK, Long Beach, CA (US); Sunny SCARIA, Maharashtra (IN); Kim CHU, Costa Mesa, CA (US)

(21) Appl. No.: 17/707,138

(22) Filed: Mar. 29, 2022

(51) Int. Cl. C09D 133/16; C09D 133/08; C09D 127/16; C09D 7/61; C09D 7/63; C08K 3/34

(52) U.S. Cl. CPC C09D 133/16; C09D 133/08; C09D 127/16; C09D 7/61; C09D 7/63; C08K 3/34

(57) ABSTRACT

A fade resistant exterior paint composition includes water, a non-fluorinated acrylic binder, and a fluorinated binder that is not an acrylic. Characteristically, the weight ratio of the fluorinated binder to the non-fluorinated acrylic binder is from about 0.15 to about 0.3.

### TECHNICAL FIELD

In at least one aspect, the present invention is related to paint compositions that form coatings that resist fading caused by environmental fading.

### BACKGROUND

Current exterior paints in the market fade after being exposed to different weathering conditions. This fading is mainly due to the fading of colorants and the chalking of binders.

Accordingly, there is a need for paint compositions that form paint coatings with improved fading caused by weathering.

### SUMMARY

In at least one aspect, a fade resistant exterior paint composition is provided. The fade resistant exterior paint composition includes water, a non-fluorinated acrylic binder, and a fluorinated binder that is not an acrylic. Characteristically, the weight ratio of the fluorinated binder to the non-fluorinated acrylic binder is from about 0.15 to about 0.3.

In another aspect, coatings made from a fade resistant exterior paint composition exhibit reduced decomposition of binders after weathering and also reduced the fading of tinted colorants.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; single letters (e.g., “n” or “o”) are 1, 2, 3, 4, or 5; in the compounds disclosed herein including compounds described by formula or by name, a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; percent, “parts of” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

The term “alkyl” refers to C₁₋₂₀ inclusive, linear (i.e., “straight-chain”), branched, saturated or at least partially and in some cases fully unsaturated (i.e., alkenyl and alkynyl) hydrocarbon chains, including for example, methyl, ethyl, propyl, isopropyl, butyl, isobutyl, tert-butyl, pentyl, hexyl, octyl, ethenyl, propenyl, butenyl, pentenyl, hexenyl, octenyl, butadienyl, propynyl, butynyl, pentynyl, hexynyl, heptynyl, and alkenyl groups. “Branched” refers to an alkyl group in which a lower alkyl group, such as methyl, ethyl or propyl, is attached to a linear alkyl chain. “Lower alkyl” refers to an alkyl group having 1 to about 8 carbon atoms (i.e., a C₁₋₈ alkyl), e.g., 1, 2, 3, 4, 5, 6, 7, or 8 carbon atoms. “Higher alkyl” refers to an alkyl group having about 10 to about 20 carbon atoms, e.g., 10, 11, 12, 13, 14, 15, 16, 17, 18, 19, or 20 carbon atoms.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

Throughout this application, where publications are referenced, the disclosures of these publications in their entireties are hereby incorporated by reference into this application to more fully describe the state of the art to which this invention pertains.

In the compositions set forth herein, water makes up the balance of the composition.

### Abbreviations

“DPUR” means dirt pick-up resistance.

In an embodiment, a fade resistant exterior paint composition is provided. The fade resistant exterior paint composition includes water, a non-fluorinated acrylic binder, and a fluorinated binder that is not an acrylic. Characteristically, the weight ratio of the fluorinated binder to the non-fluorinated acrylic binder is greater than or equal to 0.15.

In a variation, the weight ratio of the fluorinated binder to the non-fluorinated acrylic binder is from about 0.15 to about 0.3. In a refinement, the weight ratio of the fluorinated binder to the non-fluorinated acrylic binder is from about 0.15 to about 0.2. In another refinement, the weight ratio of the fluorinated binder to the non-fluorinated acrylic binder is from about 0.15 to about 0.18. In some refinements, the weight ratio of the fluorinated binder to the non-fluorinated acrylic binder is from about at least in increasing order of preference, 0.08, 0.10, 0.12, 0.13, 0.14, or 0.15 and at most in increasing order of preference, 0.35, 0.30, 0.25, 0.20, 0.18, or 0.15,

In a variation, the fluorinated binder is a fluoroethylene vinyl ether resin or a polyvinylidene difluoride resin. In a refinement, the fluorinated binder is present in an amount from about 5 weight percent to 20 weight percent of the total weight of the fade resistant exterior paint composition. In another refinement, the fluorinated binder is present in an amount from about 7 weight percent to 15 weight percent of the total weight of the fade resistant exterior paint composition. In some refinements, the fluorinated binder is present in an amount of at least in increasing order of preference 3 weight percent, 5 weight percent, 7 weight percent, 10 weight percent, 12 weight percent, or 14 weight percent, of the total weight of the fade resistant exterior paint composition and at most in increasing order of preference, 30 weight percent, 25 weight percent, 20 weight percent, 18 weight percent, 17 weight percent, or 16 weight percent of the total weight of the fade resistant exterior paint composition.

Typically, useful non-fluorinated acrylic binders are selected based on exposure history with excellent weatherability on color fading delta. In a refinement, the color fading delta is less than 10. In some refinement, the color fading delta is less than in increasing order of preference 20, 15, 10, 9, 8, 7, 6, 5, 4, 3, 2, or 1. A calculation of the change in color is measured in the Hunter Lab color space on a three-dimensional axes L, a, b.

In a variation, the non-fluorinated acrylic binder is formed from one or more monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, trimethylolpropane triacrylate, pentafluorophenyl methacrylate, pentafluorophenyl acrylate, 1,1,1,3,3,3-hexafluoroisopropylacrylate, bis-(2,2,2-trifluoroethyl) itaconate, bis-(1,1,1,3,3,3-hexafluoroisopropyl), 1H,1H,3H-hexafluorobutyl acrylate, 1H, 1H,7H-dodecafluoroheptyl methacrylate, 2,2,2-trifluoroethyl acrylate, 2,2,2-trifluoroethyl methacrylate, aliphatic, fluorinated aliphatic, 1H,1H,2H,2H-Heptadecafluorodecyl methacrylate 532.2 acrylic, 1H,1H,2H,2H-heptadecafluorodecyl acrylate, 1H, 1H,5H-octafluoropentyl acrylate, 1H, 1H,3H-tetrafluoropropyl methacrylate, hexafluoro-iso-propyl methacrylate, 1H,1H,3H-hexafluorobutyl methacrylate, 1H,1H,5H-octafluoropentyl methacrylate, ethylene, propylene, 1-butylene, 2 butylene, vinyl acetate, functional monomers, acid group monomers, and combinations thereof. In this context, the phrase “formed from one or more monomers” means that a reaction mixture for forming the non-fluorinated acrylic binders includes the designated monomers. In a further refinement, the non-fluorinated acrylic binder is formed from one or more monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, and combinations thereof.

In a variation, the non-fluorinated acrylic binder is present in an amount from about 20 weight percent to 45 weight percent of the total weight of the fade resistant exterior paint composition.

In another variation with improved flexibility, the fade resistant exterior paint composition includes a flexible acrylic binder having a low glass transitions temperature. In a variation, the flexible acrylic binder has a glass transition temperature less than about 15° C. In a refinement, the fade resistant exterior paint composition includes a flexible acrylic binder has a glass transition temperature less than about 10° C. In some refinements, he fade resistant exterior paint composition includes a flexible acrylic binder has a glass transition temperature less than, in increasing order of preference, 20° C., 15° C. 10° C. 5° C. 0° C. or −5° C.

In typical applications, the paint composition can include one or more paint additives in relatively low amounts in order to provide important properties to the paint composition. Typical paint additives include pigments, rheology modifiers, defoamers, surfactants, pH modifiers (e.g., ammonia), suspending agents, defoamers, organic solvents, dispersants, coalescents, UV light stabilizers (e.g., Hindered amine light stabilizer such as Tinuvin® 292), biocides, matting agents, opaque polymers, mildewcides, and combinations thereof. In a variation, the paint additives are collectively present in an amount from about 0.1 to 20 weight percent. In a refinement, the paint additives are collectively present in an amount from about 1 to 20 weight percent. It should be appreciated that other well-known paint additives can be utilized to provide additional properties. In a refinement, each of the following paint additives is independently optionally present in an amount greater than 0.01, 0.05, 1.0, 2.0, 3.0, or 4.0 weight percent of the total weight of the fade resistant exterior paint composition and in an amount less than, 20.0, 15.0, 10.0, 9.0, 8.0, 7.0, or 6.0 weight percent of the total weight of the fade resistant exterior paint composition: pigments, rheology modifiers, surfactants, defoamers, organic solvents, matting agent, pH modifiers, ammonia, low viscosity coalescent, dispersants, synthetic opaque polymer pigment, coalescents, light stabilizers, and biocides.

In a refinement, the fade resistant exterior paint composition independently includes 0.01 to 3 weight percent rheology modifiers, 0.01 to 3 weight percent surfactants, 0.01 to 5 weight percent defoamers, 0.01 to 3 weight percent dispersants, 0.1 to 5 weight percent coalescents, 0.01 to 5 weight percent biocides, 0.01 to 3 weight mildewcides, 0.01 to 3 weight pH adjusters, 0.1 to 10 weight percent opaque polymer, and 0.2 to 10 matting agents. In a refinement, the fade resistant exterior paint composition includes fillers, and in particular, micronized fillers in an amount from about 5 weight percent to about 18 weight percent of the fade resistant exterior paint composition. An example of a micronized filler is nepheline syenite.

In another refinement, the fade resistant exterior paint composition includes a hydrophobically modified polyether. In a further refinement, the fade resistant exterior paint composition includes a hydrophobically modified polyether in an amount from about 0.05 to 3 weight percent of the total weight of the fade resistant exterior paint composition.

In another variation, the fade resistant exterior paint composition includes an aqueous tannin stain inhibitor additive. Typically, the aqueous tannin stain inhibitor additive is present in an amount from about 0.3 to 2 weight percent of the total weight of the fade resistant exterior paint composition

In the fade resistant exterior paint compositions set forth above, the balance is typically made up of water.

In a variation, the fade resistant exterior paint compositions set forth above are made by a two-step process—the grind and the letdown. In the grind step, the solvent (water), dispersant, defoamer, and pigments are mixed together. In the letdown step, the siloxane-containing emulsion, the mildewcide, if present, the rheology modifier, if present, and the biocide, if present, are added to the grind product.

The following examples illustrate the various embodiments of the present invention. Those skilled in the art will recognize many variations that are within the spirit of the present invention and scope of the claims.

Table 1 provides an example of a flat white paint having improved fade resistance. Table 2 provides an example of a SG Deep paint having improved fade resistance. It should be appreciated that practice within plus and minus 20 percent or 10 percent is also contemplated.

TABLE 1
Example of Flat White paint

| | Weight |
|---|---|
| Material Description (Flat White) | Percent |
| Titanium dioxide slurry | 26.03 |
| Water (the balance) | 7.63 |
| Defoamer | 0.35 |
| Hydrophobically modified polyether | 1.06 |
| Surfactant (ethoxylated aliphatic alcohol phosphate ester.) | 0.53 |
| Dispersants | 1.23 |
| Inert powdered gelling grade of attapulgite | 0.53 |
| Micronized functional filler and/or extender produced from | 6.16 |
| nepheline syenite #1 | |
| Micronized functional filler and/or extender produced from | 4.40 |
| nepheline syenite #2 | |
| Preservative and antimicrobial | 0.40 |
| Rheology modifier (hydrophobically modified ethylene | 0.07 |
| oxide urethane) | |
| Aqueous tannin stain inhibitor additive | 0.88 |
| Hindered amine light stabilizer | 0.268 |
| Matting agent | 3.08 |
| Acrylic Emulsion | 19.61 |
| Water-based acrylic emulsion polymers | 10.60 |
| Hybrid dispersion of 70% (wt) PVDF resin and 30% (wt) | 8.00 |
| acrylic resin | |
| Defoamer | 0.31 |
| Coalescent | 1.41 |
| Coalescent | 1.28 |
| Ammonia | 0.13 |
| Synthetic opaque polymer pigment | 4.84 |
| Biocide #1 | 1.10 |
| Biocide #2 | 0.15 |

TABLE 2
Example of a SG Deep paint

| | Weight |
|---|---|
| Material Description (SG Deep) | Percent |
| Water (the balance) | 12.17 |
| Hydrophobically modified polyether | 3.88 |
| Polymeric dispersing agent | 0.47 |
| Wetting and dispersing agent (surfactant) | 0.21 |
| Hindered amine light stabilizer | 1.05 |
| Defoamer | 0.31 |
| Micronized functional filler and/or extender produced from | 6.29 |
| nepheline syenite #2 | |
| Micronized functional filler and/or extender produced from | 5.76 |
| nepheline syenite #1 | |
| Inert powdered gelling grade of attapulgite | 0.42 |
| Multifunctional Neutralize | 0.16 |
| Preservative and antimicrobial | 0.30 |
| Aqueous tannin stain inhibitor additive | 1.89 |
| Rheology modifier (hydrophobically modified ethylene | 0.319 |
| oxide urethane) | |
| Acrylic Emulsion | 30.49 |
| Water-based acrylic emulsion polymers | 16.45 |
| Defoamer | 0.37 |
| Synthetic opaque polymer pigment | 1.31 |
| Biocide | 1.31 |
| Coalescent | 1.37 |
| Coalescent | 3.04 |
| Biocide | 0.10 |
| Hybrid dispersion of 70% (wt) PVDF resin and 30% (wt) | 12.36 |
| acrylic resin | |

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fade resistant exterior paint composition comprising:
water;
a non-fluorinated acrylic binder; and
a fluorinated binder that is not an acrylic, the weight ratio of the fluorinated binder to the non-fluorinated acrylic binder is from about 0.15 to about 0.3.

2. The fade resistant exterior paint composition of claim 1, wherein the weight ratio of the fluorinated binder to the non-fluorinated acrylic binder is from about 0.15 to about 0.2.

3. The fade resistant exterior paint composition of claim 1, wherein the weight ratio of the fluorinated binder to the non-fluorinated acrylic binder is from about 0.15 to about 0.18.

4. The fade resistant exterior paint composition of claim 1, wherein the fluorinated binder is a fluoroethylene vinyl ether resin or a polyvinylidene difluoride resin.

5. The fade resistant exterior paint composition of claim 1, wherein the fluorinated binder is present in an amount from about 5 weight percent to 20 weight percent of the total weight of the fade resistant exterior paint composition.

6. The fade resistant exterior paint composition of claim 1, wherein the fluorinated binder is present in an amount from about 7 weight percent to 15 weight percent of the total weight of the fade resistant exterior paint composition.

7. The fade resistant exterior paint composition of claim 1, wherein the non-fluorinated acrylic binder is present in an amount from about 20 weight percent to 45 weight percent of the total weight of the fade resistant exterior paint composition.

8. The fade resistant exterior paint composition of claim 1, wherein the non-fluorinated acrylic binder is formed from one or more monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, trimethylolpropane triacrylate, pentafluorophenyl methacrylate, pentafluorophenyl acrylate, 1,1,1,3,3,3-hexafluoroisopropylacrylate, bis-(2,2,2-trifluoroethyl) itaconate, bis-(1,1,1,3,3,3-hexafluoroisopropyl), 1H, 1H,3H-hexafluorobutyl acrylate, 1H,1H,7H-dodecafluoroheptyl methacrylate, 2,2,2-trifluoroethyl acrylate, 2,2,2-trifluoroethyl methacrylate, aliphatic, fluorinated aliphatic, 1H,1H,2H,2H-Heptadecafluorodecyl methacrylate 532.2 acrylic, 1H,1H,2H,2H-heptadecafluorodecyl acrylate, 1H,1H,5H-octafluoropentyl acrylate, 1H, 1H,3H-tetrafluoropropyl methacrylate, hexafluoro-iso-propyl methacrylate, 1H, 1H,3H-hexafluorobutyl methacrylate, 1H,1H,5H-octafluoropentyl methacrylate, ethylene, propylene, 1-butylene, 2 butylene, vinyl acetate, functional monomers, acid group monomers, and combinations thereof.

9. The fade resistant exterior paint composition of claim 1, wherein the non-fluorinated acrylic binder is formed from one or more monomers selected from the group consisting of methacrylate, methyl acrylate, ethyl acrylate, 2-chloroethyl vinyl ether, 2-ethylhexyl acrylate, hydroxyethyl methacrylate, butyl acrylate, butyl methacrylate, and combinations thereof.

10. The fade resistant exterior paint composition of claim 1, wherein the non-fluorinated acrylic binder is formed from one or more monomers selected from the group consisting of methacrylate, methyl acrylate, ethyl acrylate, 2-ethylhexyl acrylate, hydroxyethyl methacrylate, butyl acrylate, butyl methacrylate, and combinations thereof.

11. The fade resistant exterior paint composition of claim 1, further comprising a combination of paint additives.

12. The fade resistant exterior paint composition of claim 11, wherein the combination of paint additives includes components selected from the group consisting of rheology modifiers, surfactants, defoamers, organic solvents, pH adjusters, UV light stabilizers, dispersants, coalescents, biocides, matting agents, opaque polymers, mildewcides, and combinations thereof.

13. The fade resistant exterior paint composition of claim 11 wherein the fade resistant exterior paint composition includes 0.01 to 3 weight percent rheology modifiers, 0.01 to 3 weight percent surfactants, 0.01 to 5 weight percent defoamers, 0.01 to 3 weight percent dispersants, 0.1 to 5 weight percent coalescents, 0.01 to 5 weight percent biocides, 0.01 to 3 weight mildewcides, 0.01 to 3 weight pH adjusters, 0.1 to 10 weight percent opaque polymer, and 0.2 to 10 matting agents.

14. The fade resistant exterior paint composition of claim 1 further comprising a flexible acrylic binder having a glass transition temperature less than about 15° C.

15. The fade resistant exterior paint composition of claim 1 further comprising a flexible acrylic binder having a glass transition temperature less than about 10° C.

16. The fade resistant exterior paint composition of claim 1 further comprising a micronized filler in an amount from about 5 weight percent to about 18 weight percent of the fade resistant exterior paint composition.

17. The fade resistant exterior paint composition of claim 16 wherein the micronized filler is nepheline syenite.

18. The fade resistant exterior paint composition of claim 16 further comprising a hydrophobically modified polyether.

19. The fade resistant exterior paint composition of claim 18, wherein the hydrophobically modified polyether is present in an amount from about 0.05 to 3 weight percent of the total weight of the fade resistant exterior paint composition.

20. The fade resistant exterior paint composition of claim 17 further comprising an aqueous tannin stain inhibitor additive.
